(19) United States
(12) Patent Application Publication
(10) Pub. No.: US 2011/0183243 A1
(43) Pub. Date: Jul. 28, 2011

(54) ELECTROPHOTOGRAPHIC PHOTORECEPTOR AND ELECTROPHOTOGRAPHIC IMAGING APPARATUS INCLUDING THE PHOTORECEPTOR

(75) Inventors: Yong-jin AHN, Seoul (KR); Saburo Yokota, Suwon-si (KR); Zbig Tokarski, Suwon-si (KR); Hwan-koo Lee, Suwon-si (KR); Ji-uk Kim, Suwon-si (KR)

(73) Assignee: Samsung Electronics Co., Ltd., Suwon-si (KR)

(21) Appl. No.: 12/913,291

(22) Filed: Oct. 27, 2010

(30) Foreign Application Priority Data
Jan. 22, 2010 (KR) 2010-6048

(51) Int. Cl. G03G 15/00

(52) U.S. Cl. 430/56; 399/159; 430/58.05

(57) ABSTRACT

The disclosure provides an electrophotographic photoreceptor and an electrophotographic imaging apparatus including the photoreceptor, wherein the electrophotographic photoreceptor comprises: a conductive substrate; a charge generating layer formed on the conductive substrate; a charge transport layer formed on the charge generating layer; and an overcoat layer formed on the charge transport layer, wherein the ratio (R2/R1) of the surface resistance value (R2) of the overcoat layer to the surface resistance value (R1) of the charge transport layer is from about 0.01 to about 1.5.

### CROSS-REFERENCE TO RELATED PATENT APPLICATION

This application claims the benefit of Korean Patent Application No. 10-2010-0006048, filed in the Korean Intellectual Property Office on Jan. 22, 2010, the disclosure of which is hereby incorporated by reference in its entirety for all purposes.

### TECHNICAL FIELD

1. Field of the Invention

The present disclosure generally relates to an electrophotographic photoreceptor and an electrophotographic imaging apparatus including the photoreceptor.

2. Background of the Disclosure

An electrophotographic imaging apparatus used in laser printers, photocopiers, CRT printers, facsimile machines, LED printers, large plotters, laser photographs, and the like, prints an image according to the following general process. First, the surface of the photosensitive layer of an electrophotographic photoreceptor is uniformly and electrostatically charged. The charged surface of the photosensitive layer is then exposed to a pattern of light to form an image. A pattern of charged and non-charged areas, a so-called latent image, is formed in response to light exposure by selectively dissipating electric charges in the irradiation area upon which the light is incident. Next, a wet or dry toner is provided to an area adjacent to the latent image, and toner particles are adhered onto the latent image to form a toner image on the surface of the photosensitive layer. The toner image may be transferred onto an appropriate final or intermediate receiving medium such as paper, or the photosensitive layer may function as a final receptor of the image.

The electrophotographic photoreceptor may be formed in the shape of a plate, a disk, a sheet, a belt, a drum, and the like, which may be negatively-charged or positively-charged. Frequently used at present is a negatively-charged photoreceptor, which is exposed to light by applying negative (−) electrical charges to its surface. However, due to problems such as ozone generation, limits in resolution improvement, and so on, studies on using a positively-charged photoreceptor, which is exposed to light by applying positive (+) electrical charges to its surface, are also being pursued.

An image forming apparatus generally includes a paper feeding unit for feeding paper, a laser scanning unit for scanning a laser beam to a photosensitive drum, a fusing unit for fixing toner onto paper, a developing unit for developing the latent image with developer and a paper discharge unit for discharging an image-fused paper. In order to print a desired image on paper, the various units of the image forming apparatus operate in conjunction with one another to sequentially perform the image forming process. As the number of paper sheets to be printed increases however, the printed paper images may deteriorate since the parameters of the light sensitive drum, laser scanning unit, developing unit, and fusing unit may vary over time.

### SUMMARY OF THE DISCLOSURE

One aspect the disclosure provides an electrophotographic photoreceptor including a conductive substrate; a charge generating layer formed on the conductive substrate; a charge transport layer formed on the charge generating layer and an overcoat layer formed on the charge transport layer, wherein the ratio (R2/R1) of the surface resistance value (R2) of the overcoat layer to the surface resistance value (R1) of the charge transport layer is from about 0.01 to about 1.5.

In another aspect the disclosure, there is provided an electrophotographic photoreceptor, wherein the overcoat layer comprises a binder resin and a conductive material.

In another aspect the disclosure, there is provided an electrophotographic photoreceptor, wherein the overcoat layer is a photocuring product of an overcoat layer-forming composition that includes a photocurable compound, a photoinitiator, a conductive material and a solvent.

In another aspect the disclosure, there is provided an electrophotographic photoreceptor, wherein the photocurable compound is selected from a mono-functional methacrylic acid ester, a bi-functional methacrylic acid ester, a tri- or higher functional methacrylic acid ester, or combination thereof.

In another aspect the disclosure, there is provided an electrophotographic photoreceptor, wherein the conductive material is selected from copper, tin, aluminum, indium, silica, tin oxide, zinc oxide, titanium dioxide, aluminum oxide (Al₂O₃), zirconium oxide, indium oxide, antimony oxide, bismuth oxide, calcium oxide, ATO (antimony doped tin oxide), carbon nanotubes, or combination thereof.

In another aspect the disclosure, there is provided an electrophotographic photoreceptor, wherein the overcoat layer-forming composition comprises from about 1 to about 20 weight parts of a photoinitiator, from about 5 to about 40 weight parts of conductive material, and from about 300 to about 700 weight parts of a solvent, based on 100 weight parts of the photocurable compound.

In another aspect the disclosure, there is provided an electrophotographic photoreceptor, wherein the overcoat layer has a thickness of about 0.5 to about 4 μm.

In another aspect the disclosure, there is provided an electrophotographic photoreceptor, further including an undercoat layer formed between the conductive substrate and the charge generating layer.

In another aspect the disclosure, there is provided an electrophotographic photoreceptor, which further includes a metal oxide layer formed between the conductive substrate and the undercoat layer.

In another aspect the disclosure, there is provided an electrophotographic photoreceptor, which further includes a metal oxide layer formed between the conductive substrate and the charge generating layer.

In another aspect the disclosure, there is provided an electrophotographic imaging apparatus including an electrophotographic photoreceptor, a charging device charging the electrophotographic photoreceptor, an exposure device forming electrostatic latent images on the surface of the electrophotographic photoreceptor and a developing device for developing the electrostatic latent images. The electrophotographic photoreceptor includes a conductive substrate, a charge generating layer formed on the conductive substrate, a charge transport layer formed on the charge generating layer and an overcoat layer formed on the charge transport layer. The ratio (R2/R1) of the surface resistance value (R2) of the overcoat layer to the surface resistance value (R1) of the charge transport layer is from about 0.01 to about 1.5.

In another aspect the disclosure, there is provided an electrophotographic photoreceptor having a long lifespan due to improved wear resistance. The image forming apparatus includes the electrophotographic photoreceptor capable of reducing image deterioration due to photoreceptor wear, i.e., reduction in thickness of the photoreceptor, in spite of increase of the number of paper sheets to be printed.

### BRIEF DESCRIPTIONS OF DRAWINGS

Various features and advantages of the disclosure will become apparent by describing in detail exemplary embodiments thereof with reference to the attached drawings in which:

FIG. 1 is a diagram illustrating an electrophotographic imaging apparatus according to an embodiment of the present disclosure; and

FIG. 2 is a graph for evaluating changes in the optical density versus the rotation number of the photoreceptor for an electrophotographic photoreceptor according to an embodiment of the present disclosure.

### DETAILED DESCRIPTION OF THE DISCLOSURE

The disclosure will now be described more fully with reference to the accompanying drawings, in which several embodiments of the disclosure are shown.

The disclosure provides an electrophotographic photoreceptor that includes: a conductive substrate; a charge generating layer formed on the conductive substrate; a charge transport layer formed on the charge generating layer; and an overcoat layer formed on the charge transport layer, wherein the ratio (R2/R1) of the surface resistance value (R2) of the overcoat layer to the surface resistance value (R1) of the charge transport layer is from about 0.01 to about 1.5.

Examples of the conductive substrate include, but are not limited to, metallic materials such as aluminum, aluminum alloys, stainless steel, copper, nickel, and the like. Other examples of the conductive substrate include, but are not limited to, insulating substrates such as polyester film, paper, glass, and the like, having conductive layers of aluminum, copper, palladium, tin oxide, indium oxide, formed on the surface thereof. The insulating substrates may be formed in the form of a drum, a pipe, a belt, a plate, and the like. The conductive substrate may also include a photosensitive layer formed thereon. The photosensitive layer may include charge generating material. The charge transport layer may include charge transporting material.

The charge generating layer may include a binder resin and charge generating material dispersed or dissolved into the binder resin. Examples of the charge generating material include, but are not limited to, organic pigments or dyestuffs such as phthalocyanine based compounds, perylene based compounds, perynone based compounds, indigo based compounds, quinacridone based compounds, azo based compounds, bis-azo based compounds, tris-azo based compounds, bis-benzoimidazole based compounds, polycycloquinone based compounds, pyrrolopyrrole compounds, non-metallic naphthalocyanine based compounds, metallic naphthalocyanine based compounds, squaraine based compounds, squarylium based compounds, azulenium based compounds, quinone based compounds, cyanine based compounds, pyrylium based compounds, anthraquinone based compounds, triphenyl methane based compounds, styrene based compounds, toluidine based compounds, pyazoline based compounds, quinacridone based compounds and the like, and combinations thereof.

A non-metallic phthalocyanine based pigment represented by formula 1:

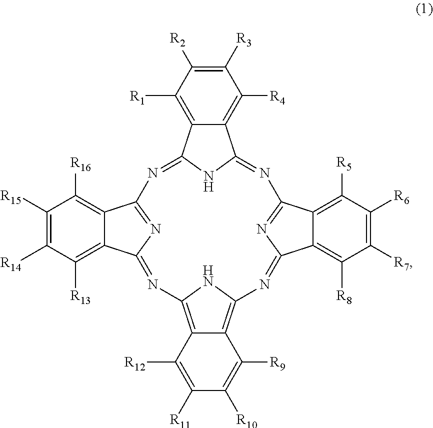

or a metallic phthalocyanine based pigment represented by formula 2:

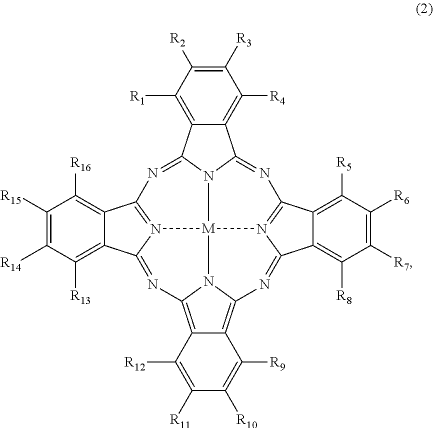

or a combination thereof, may be used as the charge generating material, where R1 to R16 are each independently selected from hydrogen, halogen, nitro, alkyl and alkoxy; and where M is independently selected from copper, chloroaluminum, chloroindium, chlorogallium, chlorogermanium, oxyvanadyl, oxytitanyl, hydroxygermanium and hydroxygallium.

Examples of the metallic phthalocyanine based pigment represented by the foregoing chemical formula 2 include, but are not limited to, oxotitanyl phthalocyanine based pigments, titanyl phthalocyanine based pigments, copper phthalocyanine based pigments, hydroxygallium phthalocyanine based pigments and the like.

The non-metallic phthalocyanine based pigment may be X or tau crystal type. The metallic phthalocyanine based pigment may be Y oxytitanyl phthalocyanine, α oxytitanylphthalocyanine, or the like. When considering aspects of the improvement in photosensitivity and the stability in dispersion, the phthalocyanine based pigments of the foregoing formulas 1 and 2 are not particularly limited in their crystal types.

When the phthalocyanine based compounds are used as the charge generating material, a phthalocyanine based compound or combinations thereof, may be used to provide absorption wavelengths within desired range. It may not be necessary to use a binder resin if the charge generating material has film-forming ability. However, a charge generating material with low molecular weight may not have this capability, and therefore may also require the use of a binder resin to form a charge transport layer.

Examples of binder resin for the charge generating layer includes, but are not limited to, polycarbonate, polyarylate such as condensation polymers of bisphenol A and phthalic acid, polyamide, polyester, acrylic resin, methacrylic resin, polyvinyl chloride, vinylidene polychloride, polystyrene, polyvinyl acetate, styrene-butadiene copolymer, vinylidene chloride-acrylonitrile copolymer, vinylchloride-vinylacetate copolymer, vinylchloride-vinyl-acetate-maleic anhydride copolymer, silicone resin, silicone-alkyd resin, phenol-formaldehyde resin, styrene-alkyd resin, polyvinyl acetal such as polyvinyl butyral and polyvinyl formal, polysulfone, casein, gelatin, polyvinyl alcohol, polyamide, cellulose based resin such as ethyl cellulose, carboxymethyl cellulose, polyurethane, polyacrylamide resin, polyvinyl pyridine, epoxy resin, polyketone, polyacrylonitrile, melamine resin, polyvinyl pyrrolidone and the like. The binder resin for the charge generating layer is not limited to these examples. Such binder resins may be used independently or in the form of mixtures thereof. Other examples of the binder resin for the charge generating layer may include, but are not limited to, organic photoconductive resins such as poly N-vinylcarbazole, polyvinyl anthracene, polyvinyl pyrene, and the like. If an undercoat layer is formed between the conductive substrate and the charge generating layer, polyvinyl butyral resin may be used as the binder resin due to its adhesive property and particle dispersibility of phthalocyanine based charge generating material.

The amounts of the charge generating material and binder resin are not limited, and may be selected within ordinarily available ranges as occasion demands. The charge generating material may be in the range of about 10 to about 500 weight parts or in the range of about 10 to about 100 weight parts based on 100 weight parts of the binder resin. If the charge generating material is within the above ranges, the amount of electric charges generated is sufficient to prevent an increase of residual electric potential due to insufficient sensitivity, whereas the resin in the charge generating layer is appropriate to improve the mechanical strength of the charge generating layer and to also improve the dispersion stability of the charge generating material.

A composition including a charge generating material, a binder resin and a solvent may be coated to form the charge generating layer. The solvent may be used without limitation if it does not influence an adjacent layer during coating of the composition. The solvent may have polar index value ranges of 0 to 4, 0 to 3, and 0 to 2.5. Specific examples of such a solvent include, but are not limited to, aromatic hydrocarbons such as benzene, xylene, ligroin, monochlorobenzene, dichlorobenzene, and the like; ketones such as acetone, methyl ethyl ketone, cyclohexanone, and the like; alcohols such as methanol, ethanol, isopropanol, n-propanol, n-butanol, and the like; esters such as ethyl acetate, methyl cellosolve, and the like; aliphatic halogenated hydrocarbons such as carbon tetrachloride, chloroform, dichloromethane, dichloroethane, trichloroethylene, and the like; ethers such as tetrahydrofuran, dioxane, dioxolane, ethylene glycol monomethyl ether, and the like; amides such as N,N-dimethyl formamide, N,N-dimethyl acetamide, and the like; and sulfoxides such as dimethyl sulfoxide and the like. The solvent may be used independently or in combinations thereof.

The charge generating layer may further include an electron-acceptor material for improving the sensitivity, reducing the residual electric potential, and/or reducing fatigue in case of repetitive usage. Specific examples of electron-acceptor materials include, but are not limited to, compounds with high electron affinity such as succinic anhydride, maleic anhydride, succinic anhydride dibromide, phthalic anhydride, 3-nitro phthalic anhydride, 4-nitro phthalic anhydride, pyromellitic anhydride, pyromellitic acid, trimellitic acid, trimellitic anhydride, phthalimide, 4-nitro phthalimide, tetracyanoethylene, tetracyanoquinodimethane, chloranil, bromanil, o-nitro benzoic acid, p-nitro benzoic acid, and the like. The electron-acceptor material may be about 0.01 to about 100% by weight based on the weight of the charge generating material.

The charge generating layer may be formed by milling and preparing the above-mentioned composition including the charge generating material, binder resin and solvent and optionally including the electron-acceptor material; coating the composition on the conductive substrate or coating the composition on the undercoat layer if an undercoat layer is formed between the conductive substrate and charge generating layer; and drying the composition coated on the conductive substrate or undercoat layer. The method of milling the composition to finely dispersed metal oxide particles may be performed using well-known devices such as ball mill, sand mill, paint shaker and the like. In this case, beads made of glass, alumina, stainless steel and the like, having a diameter of about 0.1 to about 5 mm, may ordinarily be used. The method of coating the composition is not particularly limited, and examples of the coating method include, but are not limited to, well-known dip coating, spray coating, spin coating, wire bar coating, ring coating and the like. The drying process after the coating process may be carried out at about 50° C. to about 200° C. for about 5 minutes to about 2 hours.

The charge generating layer may have a thickness range of about 0.1 to about 20 μm, or about 1 to about 5 μm. If the thickness of the charge generating layer is within the range of about 0.1 to about 20 μm, the charge generating layer may be uniformly formed, the charge generating layer may exhibit sufficient photosensitivity and mechanical durability, and the total thickness of an entire photosensitive layer including the charge transport layer and charge generating layer may be properly controlled to improve electrophotographic characteristics.

The charge transport layer may be formed on the charge generating layer. The charge transport layer includes a binder resin, and may further include a charge transporting material and a thermal stabilizer dispersed or dissolved into the binder resin. The charge transporting material includes hole transporting material transporting holes and/or electron transporting material transporting electrons. The hole transporting material as the charge transporting material may be used as a principal component if the photoreceptor is of a negatively-charged type while the electron transporting material may be used as the principal component if the photoreceptor is of a positively-charged type. If both positive and negative polarity characteristics are required, the hole transporting material and electron transporting material may be used together. It is not necessary to use the binder resin if the charge transporting material has a film-forming characteristic. However, the charge transport layer may be formed using the binder resin in case of charge transporting material with a low molecular weight since the charge transporting material with the low molecular weight does not have the film-forming ability.

The charge transporting material dispersed or dissolved into the binder resin of the charge transport layer may be a well-known hole transporting material and/or well-known electron transporting material. The hole transporting material may be a low or high molecular weight compound. Examples of the low molecular weight compound include, but are not limited to, pyrene-based compounds, carbazole based compounds, hydrazone based compounds, oxazole based compounds, oxadiazole based compounds, pyrazoline based compounds, arylamine based compounds, arylmethane based compounds, benzidine based compounds, thiazole based compounds, styryl based compounds, stilbene based compounds, butadiene based compounds, butadiene based amine compounds, and the like. The hole transporting material may be a high molecular weight compound. Examples of the high molecular weight compound include, but are not limited to, polyarylalkane, polyvinylcarbazole, halogenated polyvinylcarbazole, polyvinylpyrene, polyvinylanthracene, polyvinylacridine, and the like, formaldehyde based condensation resin such as pyrene-formaldehyde resin and ethylcarbazole-formaldehyde resin, triphenylmethane polymer, polysilane, N-acrylamidemethylcarbazole polymer, styrene copolymer, polyacenaphthene, polyindene, acenaphthylene-styrene copolymer and the like.

Examples of the electron transporting material include, but are not limited to, electron-attracting low molecular weight compounds such as benzoquinone-based compounds, naphthoquinone based compounds, anthraquinone based compounds, malononitrile based compounds, fluorenone based compounds, dicyanofluorenone based compounds, benzoquinoneimine based compounds, diphenoquinone based compounds, stilbenequinone based compounds, diiminoquinone based compounds, dioxotetracenedion based compounds, thiopyran based compounds, tetracyanoethylene based compounds, tetracyanoquinodimethane based compounds, xanthone based compounds, phenanthraquinone based compounds, phthalic anhydride based compounds, naphthalene based compounds, and the like. However, the electron transporting material is not limited to the electron-attracting low molecular weight compounds, and high molecular weight compounds with electron transportability, pigments with electron transportability, and the like, may also be used as the electron transporting material. The electron transporting material may be used independently or in combinations thereof.

Combinations of butadiene based amine compounds and hydrazone based compounds, or benzidine based compounds may be used as the charge transporting material to suppress image deterioration due to repetitive use of the photoreceptor. If there are materials with an electric charge mobility faster than 10⁻⁸ cm²/s, such materials may be used even if such materials are not one of the foregoing hole transporting material and electron transporting material.

The binder resin may be used without limitation if it is an insulating resin with a film-forming characteristic. Specific examples of the binder resin include, but are not limited to, polycarbonate, polyarylate such as condensation polymers of bisphenol A and phthalic acid, polyamide, polyester, acrylic resin, methacrylic resin, polyvinyl chloride, vinylidene polychloride, polystyrene, polyvinyl acetate, styrene-butadiene copolymer, vinylidene chloride-acrylonitrile copolymer, vinylchloride-vinylacetate copolymer, vinylchloride-vinyl-acetate-maleic anhydride copolymer, silicone resin, silicone-alkyd resin, phenol-formaldehyde resin, styrene-alkyl resin, polyvinyl acetal such as polyvinyl butyral and polyvinyl formal, polysulfone, casein, gelatin, polyvinyl alcohol, polyamide, cellulose based resin such as ethyl cellulose, carboxymethyl cellulose, polyurethane, polyacrylamide resin, polyvinyl pyridine, epoxy resin, polyketone, polyacrylonitrile, melamine resin, polyvinyl pyrrolidone, and the like. However, the binder resin is not limited to these examples. Such binder resins may be used dependently or in the form of mixtures thereof. The binder resin may further include organic photoconductive resins such as poly N-vinylcarbazole, polyvinyl anthracene, polyvinyl pyrene, and the like.

The amounts of the charge transporting material and binder resin in the charge transport layer are not particularly limited, and the charge transporting material and binder resin may be selected within ordinarily available ranges as occasion demands. The charge transporting material may be in the range of about 10 to about 200 weight parts or in the range of about 20 to about 150 weight parts based on 100 weight parts of the binder resin. If the charge transporting material is within the range of about 10 to about 200 weight parts, the charge transporting characteristic is sufficient to prevent increase of a residual electric potential due to insufficient sensitivity, and to improve mechanical strength of the charge transport layer.

A composition including a charge transporting material, a binder resin, and a solvent may be coated to form the charge transport layer. The solvent may be used without limitation if it does not influence an adjacent layer during coating of the composition. Specific examples of such a solvent include, but are not limited to, aromatic hydrocarbons such as benzene, xylene, ligroin, monochlorobenzene, dichlorobenzene and the like; ketones such as acetone, methyl ethyl ketone, cyclohexanone and the like; alcohols such as methanol, ethanol, isopropanol, n-propanol, n-butanol and the like; esters such as ethyl acetate, methyl cellosolve and the like; aliphatic halogenated hydrocarbons such as carbon tetrachloride, chloroform, dichloromethane, dichloroethane, trichloroethylene and the like; ethers such as tetrahydrofuran, dioxane, dioxolane, ethylene glycol monomethyl ether and the like; amides such as N,N-dimethyl formamide, N,N-dimethyl acetamide, and the like; and sulfoxides such as dimethyl sulfoxide, and the like. The solvent may be used independently or in combinations thereof.

The charge transport layer may be formed by milling and preparing the above-mentioned composition including the charge transporting material, binder resin, and solvent, coating the composition on the charge generating layer, and drying the composition coated on the charge generating layer. Methods of milling and coating the composition are not particularly limited, and may be the same as those in the above-mentioned method of forming the charge generating layer. The charge transport layer may have thickness that ranges of about 2 to about 100 μm, about 5 to about 50 μm, and 10 to about 40 μm. If the thickness of the charge transport layer is within the thickness range of about 2 to about 100 μm, the charge transport layer has improved electrification characteristics, response speed and image quality.

The charge transport layer may additionally include a thermal stabilizer if necessary. Examples of thermal stabilizer usable in the charge transport layer include, but are not limited to, phenol based thermal stabilizers, phosphite based thermal stabilizers, thioether based thermal stabilizers, and the like. The thermal stabilizer in the charge transport layer may be present in the range of about 0.01 to about 15% by weight and about 0.01 to about 10% by weight based on the weight of the charge transporting material. If the thermal stabilizer is within the range of about 0.01 to about 15% by weight, the charge transport layer is expected to be capable of reducing the deterioration of image quality due to repetitive use, and to have an improvement in the durability by maintaining the film wear and interlayer adhesive strength characteristics.

Examples of the phenol based thermal stabilizers include, but are not limited to, 2,6-di-tert-butylphenol, 2,6-di-tert-butyl-4-methoxyphenol, 2,6-di-tert-butyl-4-methylphenol, 2-tert-butyl-4-methoxyphenol, 2,4-dimethyl-6-tert-butylphenol, 2-tert-butyl-phenol, 3,6-di-tert-butylphenol, 2,4-di-tert-butylphenol, 2,6-di-tert-butyl-4-ethylphenol, 2-tert-butyl-4,6-methylphenol, 2,4,6-tert-butylphenol, 2,6-di-tert-butyl-4-stearylpropionate phenol, α-tocopherol, β-tocopherol, γ-tocopherol, naphthol AS, naphthol AS-D, naphthol AS-BO, 4,4′-methylenebis(2,6-di-tert-butylphenol), 4,4′-methylenebis(6-tert-butyl-4-methylphenol), 2,2′-methylenebis(4-methyl-6-tert-butylphenol), 2,2′-methylenebis(4-ethyl-6-tert-butylphenol), 2,2′-ethylenebis(4,6-di-tert-butylphenol), 2,2′-propylenebis(4,6-di-tert-butylphenol), 2,2′-butane-bis(4,6-di-tert-butylphenol), 2,2′-ethylenebis(6-tert-butyl-m-cresol), 4,4′-butanebis-(6-tert-butyl-m-cresol), 2,2′-butanebis(6-tert-butyl-p-cresol), 2,2′-thiobis(6-tert-butylphenol), 4,4′-thiobis(6-tert-butyl-m-cresol), 4,4′-thiobis(6-tert-o-cresol), 2,2′-thiobis(4-methyl-6-tert-butylphenol), 1,3,5-trimethyl-2,4,6-tris(3,5-di-tert-butyl-4-hydroxybenzyl)benzene, 1,3,5-tri-methyl-2,4,6-tris(3,5-di-tert-amyl-4-hydroxybenzyl)benzene, 1,3,5-trimethyl-2,4,6-tris(3-tert-butyl-5-methyl-4-hydroxybenzyl)benzene, 2-tert-butyl-5-methyl-phenylaminephenol, 4,4′-bis-amino(2-tert-butyl-4-methylphenol), n-octadecyl-3-(3′,5′-di-tert-butyl-4′-hydroxyphenyl)-propionate, 2,2,4-trimethyl-6-hydroxy-7-tert-butylchroman, tetrakis(methylene-3(3,5-di-tert-butyl-4-hydroxyphenyl)propionate)methane, 1,1,3-tris(2-methyl-4-hydroxy-5-tert-butyl-phenyl)-butane and the like.

Examples of the phosphite based thermal stabilizers include, but are not limited to, trimethyl phosphite, triethyl phosphite, tri-n-butyl phosphite, trioctyl phosphite, tridecyl phosphite, tridodecyl phosphite, tristearyl phosphite, trioleyl phosphite, tristridecyl phosphite, tricetyl phosphite, dilaurylhydrodiene phosphite, diphenylmonodecyl phosphite, diphenylmono(tridecyl) phosphite, tetraphenyldipropylene glycol phosphite, 4,4′-butylidene-bis(3-methyl-6-t-phenyl-di-tridecyl)phosphite, distearyl pentaerythritol diphosphite, ditridecyl pentaerythritol diphosphite, dinonylphenyl pentaerythritol diphosphite, diphenyloctyl phosphite, tetra(tridecyl)-4,4′-isopropylidene-diphenyl diphosphite, tris(2,4-di-t-butylphenyl)phosphite, tri(2,4-di-t-amylphenyl)phosphite, tris(2-t-butyl-4-methyl-phenyl)phosphite, tri(2-ethyl-4-methylphenyl)phosphite, tri(4-nonylphenyl)-phosphite, di(2,4-di-t-butylphenyl)pentaerythritol diphosphite, di(nonylphenyl)pentaerythritol diphosphite, tris(nonylphenyl)phosphite, tris(p-tert-octyl-phenyl)phosphite, tris(p-2-butenylphenyl)-phosphate, bis(p-nonylphenyl)cyclohexyl phosphite, tetrakis(2,4-di-tert-butylphenyl)-4,4′-biphenylene diphosphite, bis(2,6-di-tert-butyl-4-methylphenyl)pentaerythritol diphosphite, 2,6-di-tert-butyl-4-ethylphenylstearyl penta-erythritol diphosphite, di(2,6-di-tert-butyl-4-methylphenyl)pentaerythritol diphosphite, 2,6-di-tert-amyl-4-methyl-phenyl pentaerythritol diphosphite and the like.

Examples of the thioether based thermal stabilizers include, but are not limited to, dilauryl thiodipropionate, dimyristyl thiodipropionate, laurylstearyl thiodipropionate, distearyl thiodipropionate, dimethyl thiodipropionate, 2-mercaptobenzimidazole, phenothiazine, octadecyl thioglycolate, butyl thioglycolate, octyl thioglycolate, thiocresol and the like.

To protect the photosensitive layer of the charge generating layer and charge transport layer, an overcoat layer may be formed on the charge transport layer. The overcoat layer may include a binder resin and a conductive material, and may be formed from a photocuring product of an overcoat layer-forming composition, which may include a photocurable compound, a photoinitiator, conductive material and a solvent. The photocurable compound is not particularly limited. However, a mono-functional methacrylic acid ester, a bi-functional methacrylic acid ester, and tri- or higher functional methacrylic acid esters as the photocurable compound may have good polymerization properties, and may improve the strength of the resulting overcoat layer.

Examples of the mono-functional methacrylic acid ester include, but are not limited to, 2-hydroxyethylacrylate, 2-hydroxyethylmethacrylate, diethylene glycol monoethylether acrylate, diethylene glycol monoethylether methacrylate, isoboronyl acrylate, isoboronyl methacrylate, 3-methoxybutyl acrylate, 3-methoxybutyl methacrylate, (2-acryloyloxy-ethyl)(2-hydroxypropyl)phthalate, (2-methacryloyloxyethyl)(2-hydroxypropyl)-phthalate, w-carboxy polycaprolactone monoacrylate and the like.

Examples of the bi-functional methacrylic acid ester include, but are not limited to, ethylene glycol diacrylate, ethylene glycol dimethacrylate, diethylene glycol diacrylate, diethylene glycol dimethacrylate, tetraethylene glycol diacrylate, tetraethylene glycol dimethacrylate, 1,6-hexandiol diacrylate, 1,6-hexandiol dimethacrylate, 1,9-nonandiol diacrylate, 1,9-nonandiol dimethacrylate, bisphenoxyethanol fluorene diacrylate, bisphenoxyethanol fluorene dimethacrylate and the like.

Examples of the tri- or higher functional methacrylic acid esters include, but are not limited to, trimethylolpropane triacrylate, trimethylolpropane trimethacrylate, pentaerythritol triacrylate, pentaerythritol trimethacrylate, pentaerythritol tetraacrylate, pentaerythritol tetramethacrylate, dipentaerythritol pentaacrylate, dipentaerythritol pentamethacrylate, dipentaerythritol hexaacrylate, dipentaerythritol hexamethacrylate, tri(2-acryloyloxyethyl)-phosphate, tri(2-methacryloyloxyethyl)phosphate, and polyfunctional urethaneacrylate based compounds such as nona- or higher functional methacrylate esters, and the like. Such compounds may be obtained by reacting compounds having straight chain alkylene groups, alicyclic structures and two or more isocyanate groups with compounds having one or more hydroxyl groups and 3, 4 or 5 acryloyloxy groups and/or methacrylolyoxy groups in molecules.

The mono-functional, bi-functional, and tri- or higher functional methacrylate esters may be used independently or in combinations thereof. The tri- or higher functional methacrylate esters may be used particularly for improving wear resistance due to their ability to form the highest cross-linking among the methacrylate esters. Examples of the tri- or higher functional methacrylate esters include, but are not limited to, trimethylolpropane triacrylate, pentaerythritol triacrylate, pentaerythritol tetraacrylate, dipentaerythritol pentaacrylate, dipentaerythritol hexaacrylate, polyfunctional urethaneacrylate based compounds and the like.

Examples of the conductive material include, but are not limited to, copper, tin, aluminum, indium, silica, tin oxide, zinc oxide, titanium dioxide, aluminum oxide (Al₂O₃), zirconium oxide, indium oxide, antimony oxide, bismuth oxide, calcium oxide, ATO (antimony doped tin oxide), carbon nanotubes and the like. The conductive material in the overcoat layer-forming composition may be present in ranges of about 5 to about 40 weight parts and about 15 to about 25 weight parts based on 100 weight parts of the photocurable compound. If the conductive material is within the range of about 5 to about 40 weight parts, the charge transporting characteristic is sufficient to prevent increase of a residual electric potential due to insufficient sensitivity, and the electrification capability and mechanical strength of the overcoat layer may be improved. Since the overcoat layer is formed by evaporating the solvent in the overcoat layer-forming composition, the amount of the conductive material in the composition eventually corresponds to that of the conductive material in the overcoat layer to be formed.

The photoinitiator may be used without limitation if it generates radicals by exposing the photoinitiator to lights such as visible rays, ultraviolet rays, far-ultraviolet rays, charged particle beams, and the like. Specific examples of the photoinitiator include, but are not limited to, O-acyloxime based compounds, acetophenone based compounds, non-imidazole based compounds, benzoin based compounds, benzophenone based compounds, a-diketone based compounds, polynuclear quinine based compounds, xanthone based compounds, phosphine based compounds, triazine based compounds and the like.

Examples of the O-acyloxime based compounds include, but are not limited to, 1-[9-ethyl-6-benzoyl-9.H.-carbazole-3-il]-nonane-1,2-nonane-2-oxime-O-benzoate, 1-[9-ethyl-6-benzoyl-9.H.-carbazole-3-il]-nonane-1,2-nonane-2-oxime-O-acetate, 1-[9-ethyl-6-benzoyl-9.H.-carbazole-3-il]-pentane-1,2-pentane-2-oxime-O-acetate, 1-[9-ethyl-6-benzoyl-9.H .-carbazole-3-il]-octane-1-onoxime-O-acetate, 1-[9-ethyl-6-(2-methylbenzoyl)-9.H.-carbazole-3-il]-ethane-1-onoxime-O-benzoate, 1-[9-ethyl-6-(2-methylbenzoyl)-9.H.-carbazole-3-il]ethane-1-onoxime-O-acetate, 1-[9-ethyl-6-(1,3,5-trimethylbenzoyl)-9.H.-carbazole-3-il]-ethane-1-onoxime-O-benzoate, 1-[9-butyl-6-(2-ethylbenzoyl)-9.H.-carbazole-3-il]ethane-1-onoxime-O-benzoate, ethanone, 1-[9-ethyl-6-[2-methyl-4-(2,2-dimethyl-1,3-dioxolanyl)-methoxybenzoyl]-9.H.-carbazole-3-il], 1-(O-acetyloxime), 1,2-octa-dion-1-[4-(phenylthio)-phenyl]-2-(O-benzoyloxime), 1,2-butanedion-1-[4-(phenylthio)-phenyl]-2-(O-benzoyloxime), 1,2-butanedion-1-[4-(phenylthio)phenyl]-2-(O-acetyloxime), 1,2-octadion-1-[4-(methylthio)-phenyl]-2-(O-benzoyloxime), 1,2-octadion-1-[4-(phenylthio)-phenyl]-2-(O-(4-methylbenzoyl-oxime)) and the like. The O-acyloxime based compounds may be used independently or in combinations thereof.

Examples of the acetophenone based compounds include, but are not limited to, α-hydroxyketone based compounds, α-aminoketone based compounds and the like.

Examples of the α-hydroxyketone based compounds include, but are not limited to, 1-phenyl-2-hydroxy-2-methylpropane-1-on, 1-(4-i-propylphenyl)-2-hydroxy-2-methyl-pro-pane-1-on, 4-(2-hydroxyethoxy)phenyl-(2-hydroxy-2-propyl)ketone, 1-hydroxycyclohexyl phenylketone and the like.

Examples of the α-aminoketone based compounds also include, but are not limited to, 2-methyl-1-(4-methylthiphenyl)-2-morpholinopropane-1-on, 2-benzyl-2-dimethylamino-1-(4-morpholinophenyl)-butane-1-on, 2-(4-methylbenzoyl)-2-(dimethylamino)-1-(4-morpholino-phenyl)-butane-1-on and the like.

In addition to the α-hydroxyketone based compounds and α-aminoketone based compounds, examples of the acetophenone based compounds may also include other compounds such as 2,2-dimethoxyacetophgenone, 2,2-diethoxyacetophenone, 2,2-dimethoxy-2-phenylaceto-phenone and the like. The acetophenone based compounds may be used independently or in combinations thereof. It is possible to further improve the sensitivity, shape, and compression strength of the overcoat layer by using the acetophenone based compounds together with the O-acyloxime based compounds.

Examples of the non-imidazole based compounds include, but are not limited to, 2,2′-bis(2-chlorophenyl)-4,4′,5,5′-tetrakis(4-ethoxycarbonylphenyl)-1,2′-non-imidazole, 2,2′-bis(2-bromophenyl)-4,4′,5,5′-tetrakis(4-ethoxycarbonylphenyl)-1,2′-non-imidazole, 2,2′-bis(2-chlorophenyl)-4,4′,5,5′-tetraphenyl-1,2′-non-imidazole, 2,2′-bis(2,4-dichloro-phenyl)-4,4′,5,5′-tetraphenyl-1,2′-non-imidazole, 2,2′-bis(2,4,6-trichlorophenyl)-4,4′,5,5′-tetraphenyl-1,2′-non-imidazole, 2,2′-bis(2-bromophenyl)-4,4′,5,5′-tetraphenyl-1,2′-non-imidazole, 2,2′-bis(2,4-dibromophenyl)-4,4′,5,5′-tetraphenyl-1,2′-non-imidazole, 2,2′-bis-(2,4,6-tribromophenyl)-4,4′,5,5′-tetraphenyl-1,2′-non-imidazole and the like. The non-imidazole based compounds may be used independently or in combinations thereof. It is possible to further improve the sensitivity, resolution and adhesion by using the non-imidazole based compounds together with the O-acyloxime based compounds.

If the non-imidazole based compounds are used as the photoinitiator, aliphatic or aromatic compounds having dialkyl amino groups, which are referred to as “an amino based sensitizer,” may be added to increase or decrease the non-imidazole based compounds.

Examples of the amino based sensitizer include, but are not limited to, N-methyldiethanolamine, 4,4′-bis(dimethylamino)benzophenone, 4,4′-bis(diethylamino)benzo-phenone, p-dimethylaminobenzoic acid ethyl, p-dimethylaminobenzoic acid and the like. The amino based sensitizers may be used independently or in combinations thereof.

Commercially available products of the photoinitiator include, but are not limited to, Irgacure127, Irgacure184, Irgacure819, Irgacure127 and Irgacure754 manufactured by Ciba Specialty Chemical Corporation, and the like.

The photoinitiator may be present in ranges of about 1 to about 20 weight parts and about 2 to about 10 weight parts based on 100 weight parts of the photocurable compound. If the photoinitiator is within the range of about 1 to about 20 weight parts, sufficient curing reaction may take place to form an overcoat layer with a high hardness, resulting in an increase in the mechanical strength that in turn improves the wear resistance.

Specific examples of the solvent include, but are not limited to, aromatic hydrocarbons such as benzene, xylene, ligroin, monochlorobenzene, dichlorobenzene and the like; ketones such as acetone, methyl ethyl ketone, cyclohexanone and the like; alcohols such as methanol, ethanol, isopropanol, n-propanol, n-butanol, and the like; esters such as ethyl acetate, methyl cellosolve, and the like; aliphatic halogenated hydrocarbons such as carbon tetrachloride, chloroform, dichloromethane, dichloroethane, trichloroethylene, and the like; ethers such as tetrahydrofuran, dioxane, dioxolane, ethylene glycol monomethyl ether, and the like; amides such as N,N-dimethyl formamide, N,N-dimethyl acetamide, and the like; and sulfoxides such as dimethyl sulfoxide, and the like. The solvent may be used independently or in combinations thereof. The solvent may be present in a range of about 300 to about 700 weight parts and about 400 to about 600 weight parts based on 100 weight parts of the photocurable compound. If the solvent is within the range of about 300 to about 700 weight parts, a wear resistant overcoat layer may be provided by uniformly dissolving respective constituents constituting the overcoat layer-forming composition and completely removing the solvent during the formation of the overcoat layer.

The overcoat layer may be formed through coating, drying and photocuring steps. Examples of the coating techniques include, but are not limited to, well-known dip coating, spray coating, spin coating, wire bar coating, ring coating methods and the like. After coating, the drying process may be carried out at about 50° C. to about 200° C. for about 5 minutes to about 30 minutes. After the solvent is evaporated by drying, the photocuring process is conducted on the composition using a system for ultraviolet curing, wherein lamps of the photocuring system are used in a power range of about 80 to about 120 W while curing the composition. The photoreceptor may be rotated to uniformly cure the photoreceptor. The rotational speed of the photoreceptor may be about 5 to about 40 rpm, or about 20 rpm. The curing time varies according to thickness of the overcoat layer and according to the rotational speed of the photoreceptor, but it is typically in a range of about 20 to about 100 seconds. The curing time may be in the range of about 20 to about 100 seconds in order to prevent deterioration of the sensitivity characteristics of the photoreceptor possibly resulting from an incomplete or excessive curing.

The thickness of the overcoat layer formed as described herein may be in the range of about 0.5 to about 10 μm, and about 0.5 to about 4 μm. The thickness of the overcoat layer as a protection layer is within the range of about 0.5 to about 10 μm in order to prevent an insufficient effect of the protection layer or quality deterioration in printing images generated when the overcoat layer is too thin.

The ratio (R2/R1) of the surface resistance value (R2) of the overcoat layer to the surface resistance value (R1) of the charge transport layer is from about 0.01 to about 1.5. For instance, the ratio (R2/R1) is from about 0.03 to about 0.5. If the ratio (R2/R1) is within the range of about 0.01 to about 1.5, holes formed in the charge generating layer are transported to the charge transport layer and to the overcoat layer effectively such that the latent image formed has a lower exposure electric potential value as compared with a non-latent image formed portion on the surface of the photoreceptor. As a result, the adhesion of the toner particles of appropriate polarities is better confined to correspond to the latent image formed portion such that images of high quality may be obtained.

An undercoat layer may be additionally formed between the conductive substrate and charge generating layer. The undercoat layer may be formed on the conductive substrate to improve image characteristics and the adhesion between the conductive substrate and photosensitive layer, and to prevent a dielectric breakdown of the photosensitive layer by suppressing the injection of holes. The undercoat layer-forming composition may include, but is not limited to, a binder resin, metal oxide particles and a solvent.

Examples of the binder resin include, but are not limited to, polyamides, polyvinyl alcohols, polyvinyl butyrals, polyurethanes and the like. Polyamides may be used as the binder resin in consideration of adhesion with the substrate, solvent resistance, coatability, electric barrier characteristics and the like. Examples of the polyamides include, but are not limited to, nylon 6 resin, nylon 612 resin, copolymerized nylon and the like. It is possible to reduce environmental dependence by using a polyamide resin selected from polyamides, wherein the polyamide resin has a saturated water absorptivity of 5% or lower measured in accordance with the ASTM D570 method. An example of the copolymerized nylon include, but is not limited to, CM8000, a product manufactured by Toray Industries Incorporated of Japan.

Examples of the metal oxide particles include, but are not limited to, tin oxide particles, indium oxide particles, zinc oxide particles, titanium dioxide particles, silicon oxide particle, zirconia particles, alumina particles and the like, and combinations thereof. Among the metal oxide particles, the titanium dioxide particles are capable of improving electrostatic characteristics of a photosensitive drum in a low temperature and low humidity environment. Examples of the titanium dioxide particles include, but are not limited to, titanium dioxide particles of which surfaces are not treated or are hydrophilic treated. The metal oxide particles may be in first particle diameter ranges of about 100 nm or less, about 50 nm or less, and about 25 nm or less. Although lower limits of the first particle diameter ranges of the metal oxide particles are not specifically limited, the lower limits may be about 10 nm or more in view of dispersion stability. If the diameter of the metal oxide particles is within the first particle diameter range of about 100 nm or less, the photoreceptor may have sufficient electrostatic characteristics and image characteristics. Available crystal types of the metal oxide particles include, but are not limited to, amorphous, anatase, rutile and brookite crystal types.

The surfaces of the metal oxide particles may be hydrophilic. Treating the coating surfaces of the metal oxide particles with hydrophilic alumina and/or silica improves the dispersibility, environmental dependence and electrostatic characteristics. The surfaces of the metal oxide particles may be made hydrophilic by treating with silicon and the like, in order to improve environmental dependence of the undercoat layer. The metal oxide particles may be present in a range of about 20 to about 350 weight parts and about 30 to about 250 weight parts with respect to 100 weight parts of the binder resin in consideration of dispersion stability and electrostatic characteristics of the undercoat layer-forming composition. If the metal oxide particles are within the range of about 20 to about 350 weight parts, electrostatic characteristics and image characteristics of the undercoat layer-forming composition may be improved at low temperature and low humidity conditions.

A solvent of the undercoat layer-forming composition may be used without limitation if it is capable of dissolving the binder resin, and, to that end, the solvents used in the above-mentioned compositions for forming the charge generating layer and charge transport layer may be applied. Aliphatic alcohols such as methanol, ethanol, isopropanol, n-propanol, butanol, and mixtures thereof, may be used if polyamides are used as the binder resin. The amount of the solvent to be used is not particularly limited, and may be appropriately determined according to a target thickness of the undercoat layer.

An undercoat layer is formed by milling the foregoing undercoat layer-forming composition, coating the milled undercoat layer-forming composition on a conductive substrate, and drying the undercoat layer-forming composition coated on the conductive substrate. The method of forming the undercoat layer may be the same as the above-mention method of forming the charge generating layer. The undercoat layer formed may be in the range of about 0.1 to about 10 μm and about 0.5 to about 3 μm. If the thickness of the undercoat layer is within the range of about 0.1 to about 10 μm, the dielectric breakdown of the photoreceptor may be prevented, and electrostatic characteristics and image characteristics of the photoreceptor may be improved at low temperature and low humidity conditions.

One or more layers of the foregoing undercoat layer, charge generating layer, charge transport layer and overcoat layer may additionally include additives such as a plasticizer, a surface modifier, an antioxidant and the like.

Examples of the plasticizer include, but are not limited to, biphenyl, chloride biphenyl, terphenyl, dibutyl phthalate, diethylene glycol phthalate, dioctyl phthalate, triphenyl phosphate, methylnaphthalene, benzophenone, chlorinated paraffin, polypropylene, polystyrene, various fluoro hydrocarbons and the like.

Examples of the surface modifier include, but are not limited to, silicone oil, fluorine resin and the like.

Examples of the antioxidant include, but are not limited to, hindered phenol based compounds, aromatic amine based compounds, quinine based compounds and the like.

The electrophotographic photoreceptor may further include a metal oxide layer such as an anode oxide film formed between the conductive substrate and undercoat layer by using a sulfuric acid solution, oxalic acid solution, or other acid solutions. The metal oxide layer may also include an alumite film. The conductive substrate, metal oxide layer, undercoat layer, charge generating layer and overcoat layer may be sequentially formed in the electrophotographic photoreceptor.

The metal oxide layer may be formed between the conductive substrate and charge generating layer without forming the undercoat layer therebetween. In such a case, the conductive substrate, metal oxide layer, charge generating layer and overcoat layer are sequentially formed in the electrophotographic photoreceptor.

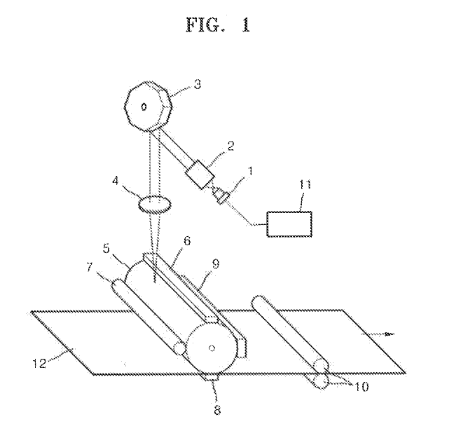

FIG. 1 is a schematic diagram of an electrophotographic imaging apparatus. Referring to FIG. 1, a light source such as, for example, a semiconductor light emitting device, is represented by reference numeral 1. Laser light, which is modulated according to image information by a control circuit 11, is emitted by the light source 1, collimated through a correction optical system 2, and is reflected by a rotation polygon mirror 3 such that the reflected laser light performs a scanning motion. The laser light is collected onto the surface of an electrophotographic photoreceptor 5 by a scanning lens 4 such that the collected laser light performs an exposure operation with respect to image information. Since the electrophotographic photoreceptor has already been charged by a charging device 6, an electrostatic latent image is formed on the surface of the electrophotographic photoreceptor by light exposure, and the electrostatic latent image is subsequently formed into a visible image by a developing device 7. The visible image is transferred on an image receptor 12 such as, for example, a sheet of paper, by a transfer device 8, and the visible image of the image receptor is fused by a fusing device 10 and the fused image of the image receptor is provided as printed matter. Any coloring agent remaining on the surface of the electrophotographic photoreceptor is removed by a cleaning device 9 such that the electrophotographic photoreceptor may be repetitively used. Although the electrophotographic photoreceptor has been illustrated in the form of a drum in the drawing, the electrophotographic photoreceptor may be formed in the form of a sheet or belt as described above.

### EXAMPLES

Aspects of the present disclosure will be better understood by referring to the following examples. The following examples are provided for the purposes of illustrating aspects of the present disclosure, and should not be construed as limiting the proper scope of the disclosure as defined by the appended claims.

### Example 1

4,000 weight parts of alumina balls with a diameter of 5 mm were added to 500 weight parts of a mixed solution of methanol and n-propanol. 70 weight parts of titanium dioxide TTO-55N (manufactured by Ishihara Sangyo Kaisha, Ltd.) having an average primary particle diameter of about 35 nm, was added to the mixture of alumina balls and mixed. Titanium dioxide was dispersed into the mixed solution by performing ball milling for 20 hours. The coating composition for the undercoat layer was prepared by diluting the mixture with 1,833 weight parts of a mixed solution of methanol and n-propanol (the weight ratio of methanol to n-propanol was 8:2), and adding the diluted mixture into a solution of nylon resin, which was prepared by dissolving 100 weight parts of a nylon resin CM8000 (manufactured by Toray Industries Incorporated). 500 weight parts of the mixed solution were then homogenized.

The undercoat layer having a thickness of about 2 μm was prepared by forming an alumite film as a metal oxide layer to a thickness of about 5 μm on a circular aluminum drum having an outer diameter of 30 mm, a length of 248 mm and a thickness of about 1 mm; coating the undercoat layer-forming composition on the alumite film by deep coating; and drying the circular aluminum drum having the undercoat layer-forming composition coated thereon in an oven at a temperature of 120° C. for 20 minutes.

The coating composition for a charge generating layer was prepared by dispersing 1 weight part of γ-type oxytitanyl phthalocyanine, 5 weight parts of polyvinyl butyral resin 6000C (manufactured by Denki Kagaku Kogyo K.K.) and 80 weight parts of cyclohexane together with alkali glass beads having a diameter of 1 to 1.5 mm using a painter shaker for 30 minutes, ball-milling the dispersion for 30 minutes, and repeating four times. 70 weight parts of cyclohexane were added to the ball-milled solution and the glass-beads were removed from the mixed solution. A charge generating layer having a thickness of about 1 μm was formed by coating the coating composition on the undercoat layer by deep coating and drying in an oven at a temperature of 120° C. for 10 minutes.

A composition for forming a charge transport layer was prepared by dissolving 4 weight parts of a stilbene based compound MPCT10 (manufactured by MPM Corporation) as the charge transporting material, 10 weight parts of polycarbonate resin TS-2050 (manufactured by Teijin Ltd.), 0.42 weight part of 2,6-di-tert-butyl-4-methylphenol as a thermal stabilizer, and 0.004 weight part of silicone oil KF-50 (manufactured by Shinetsu Chemical Co., Ltd.) into a mixed solution of 28 weight parts of THF (tetrahydrofuran) and 18.7 weight parts of toluene. A charge transport layer having a thickness of about 20 μm was formed by deep coating and drying the composition coated on the charge generating layer in an oven at a temperature of 120° C. for 30 minutes.

The overcoat layer-forming composition was prepared by dissolving 80 weight parts of dipentaerythritol pentaacrylate SR399 (manufactured by Sartomer Company Inc., Exton, Pa.), 20 weight parts of ATO (Antimony Doped Tin Oxide (SnO2)) as conductive material (FS-10P manufactured by Ishihara Sangyo Kaisha, Ltd.), and 5 weight parts of Irgacure 819 as a photoinitiator (manufactured by Ciba Specialty Chemicals Holding Inc., Basel, Switzerland) into a mixed solution of 294 weight parts of methanol and 126 weight parts of propanol. The composition was coated on the charge transport layer by deep coating, and the composition was dried in an oven at a temperature of 120° C. for 30 minutes. After drying the composition coated on the charge transport layer, a photoreceptor having an overcoat layer with a thickness of 2 μm formed thereon was prepared by curing the photoreceptor with an ultraviolet curing system (manufactured by Lichtzen Co., Ltd.) while rotating the photoreceptor coated with the composition. In the ultraviolet curing process, metal type ultraviolet lamps were used, curing power was 120 W/cm2, curing time was 60 seconds, rotation speed of the photoreceptor was 24 rpm, and the distance between the photoreceptor and lamps was 130 mm.

### Example 2

A photoreceptor was manufactured by the same method as in Example 1 except that 85 weight parts of dipentaerythritol pentaacrylate SR399 (manufactured by Sartomer Company Inc., Exton, Pa.) and 15 weight parts of ATO (Antimony Doped Tin Oxide (SnO2)) as conductive material (FS-10P manufactured by Ishihara Sangyo Kaisha, Ltd.) were used in the overcoat layer-forming composition.

### Example 3

A photoreceptor was manufactured by the same method as in Example 1 except that an overcoat layer was formed to a thickness of 1.5 μm.

### Example 4

A photoreceptor was manufactured by the same method as in Example 1 except that an overcoat layer was formed to a thickness of 2.3 μm.

### Comparative Example 1

A photoreceptor was manufactured by the same method as in Example 1 except that 20 weight parts of silicon dioxide was used as conductive material in the overcoat layer.

### Comparative Example 2

A photoreceptor was manufactured by the same method as in Example 1 except that 20 weight parts of aluminum oxide (Al2O3) was used as conductive material in the overcoat layer.

### Comparative Example 3

A photoreceptor was manufactured by the same method as in Example 1 except that the overcoat was not formed.

### Evaluation Methods

Measuring of Surface Resistance (Ω/□)

HIRESTA-UP having a Model Name MCP-HT450 (manufactured by Mitsubishi Chemical Corporation) was used to measure surface resistance (Ω/□). During the measurement, a voltage of 1,000 V was applied to the machine, and a ring type probe was used as a measurement probe. After measuring surface resistance values five times and obtaining an average value of the measured surface resistance values, the average value was determined as the measurement value.

### Measuring of Exposure Electric Potential

Apparatus Cynthia having a Model Name 92KSS (manufactured by Gentec Corporation) was used, and exposure electric potential values were measured under the following measurement conditions: 129 rpm of a rotation speed of an OPC drum, 90 degrees of an angle between electrification and exposure, and 35 degrees of an angle between the exposure and electric potential probe.

### Measuring of Surface Roughness

A surface roughness-measuring apparatus LSM having a Model Name VK-9700k (manufactured by Keyence Corporation) and an objective lens 50× were used. After sampling 12 points within a square having sizes of 50 μm×50 μm, measuring surface roughness values at the 12 points and obtaining an average value from the measured surface roughness values, the average value was determined as a surface roughness measurement value.

### Measuring of Thickness

LH-200C manufactured by Korea Kett Engineering Co., Ltd. was used. The thicknesses were measured after calibrating zero-points of three standard samples, thereby correcting the thicknesses of the samples before measuring thicknesses of the samples.

### Evaluation of Image Quality

The image quality was evaluated by printing the rotation number 1600k of an OPC (Organic Photo Conductor) using a multifunctional color machine having a Model Name C8385ND manufactured by Samsung Electronics Co., Ltd.

A summary of the electrophotographic photoreceptors according to Examples 1 to 4 are shown in Table 1 below. In this Table, the rates (R2/R1), of surface resistance values (R2) of overcoat layers to surface resistance values (R1) of charge transport layers, satisfied a range of about 0.01 to about 1.5. The electric potential value of the photoreceptors was about −50V to about −100V, at which images of high resolution could be formed by transporting holes formed in the charge generating layers to the charge transport layers and to overcoat layers promptly and smoothly.

TABLE 1

| | Surface resistance | | | | |
|---|---|---|---|---|---|
| | (Ω/□) | | | | |
| | | Charge | | Exposure | Thickness of |
| | Overcoat | transport | | electric | overcoat |
| | layer | layer | | potential | layer |
| | (R2) | (R1) | R2/R1 | (V) | (μm) |
| Example 1 | 2.30E+13 | 1.40E+14 | 0.16 | −74 | 2.0 |
| Example 2 | 3.60E+13 | 1.50E+14 | 0.24 | −96 | 2.0 |
| Example 3 | 1.50E+13 | 3.70E+14 | 0.04 | −74 | 1.5 |
| Example 4 | 2.60E+13 | 3.70E+14 | 0.07 | −70 | 2.3 |
| Comparative | 5.50E+14 | 3.10E+14 | 1.77 | −844 | 2.0 |
| Example 1 | | | | | |
| Comparative | 4.70E+14 | 1.40E+14 | 3.36 | −811 | 2.0 |
| Example 2 | | | | | |
| Comparative | 0 | 2.50E+14 | 0 | −56 | 0 |
| Example 3 | | | | | |

According to Table 2 below, the electrophotographic photoreceptor of Example 1 has a low surface roughness value in order to improve durability against scratching. Normal image quality was obtained even after rotating the photoreceptor 1000k times (i.e., million rotations), and had a surface wear thickness of about 1.5 μm, thereby having excellent lifespan characteristics as compared with an electrophotographic photoreceptor of Comparative Example 3 in which the overcoat layer was not formed.

TABLE 2

| | Surface resistance | | | | | | | |
|---|---|---|---|---|---|---|---|---|
| | (Ω/□) | | | | | | | |
| | | Charge | | Exposure | Thickness | | | |
| | Overcoat | transport | | electric | of overcoat | Surface | | Wear |
| | layer | layer | | potential | Layer | Roughness | Image | Thickness |
| | (R2) | (R1) | R2/R1 | (V) | (μm) | (μm) | quality | (μm) |
| Ex. 1 | 2.30E+13 | 1.40E+14 | 0.16 | −74 | 2.0 | 1.1 | Normal | 1.5 when |
| | | | | | | | image when | rotating |
| | | | | | | | Rotating the | the photo- |
| | | | | | | | photoreceptor | receptor |
| | | | | | | | to 1000k | to 1000k |
| Comp. | 0 | 2.50E+14 | 0 | −56 | 0 | 3.9 | Deteriorated | 23.0 when |
| Ex. 3 | | | | | | | image when | rotating |
| | | | | | | | rotating the | the photo- |
| | | | | | | | photoreceptor | receptor |
| | | | | | | | to 600k | to 600k |

### Measuring of Optical Density

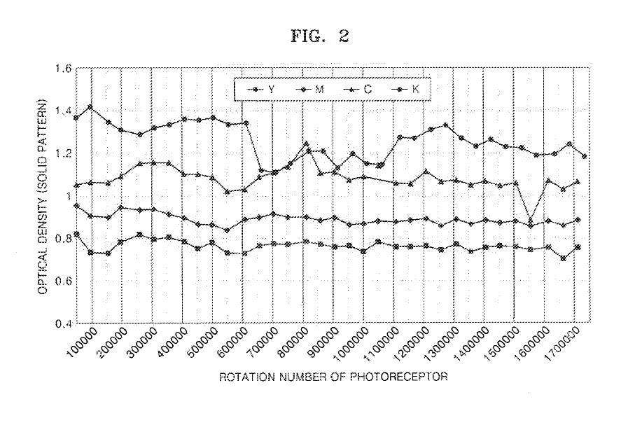

A spectrophotometer SpectroEye having a Model Name CH-8105 (manufactured by GretagMacbeth GmbH) was used. Optical density values were measured according to rotation numbers of the OPCs using the photoreceptor manufactured in Example 1 after calibrating the zero-point of the spectrophotometer SpectroEye in order to secure accuracy of the measured values. The measurement results are shown in FIG. 2.

Referring to FIG. 2, the photoreceptor according to Example 1 in which the overcoat layer was formed had excellent lifespan characteristics by allowing optical density values to maintain initial values even when the rotation number was 1600k. Such characteristics were commonly confirmed in all types of toner such as yellow (Y), cyan (C), magenta (M) and black (K) toners.

While the disclosure has been particularly shown and described with reference to exemplary embodiments thereof, it will be understood by those of ordinary skill in the art that various changes in form and details may be made therein without departing from the spirit and scope of the disclosure as defined by the following claims.

What is claimed is:

1. An electrophotographic photoreceptor comprising:
a conductive substrate;
a charge generating layer formed on the conductive substrate;
a charge transport layer formed on the charge generating layer; and
an overcoat layer formed on the charge transport layer,
wherein the ratio (R2/R1) of the surface resistance value (R2) of the overcoat layer to the surface resistance value (R1) of the charge transport layer is from about 0.01 to about 1.5.

2. The electrophotographic photoreceptor of claim 1, wherein the overcoat layer comprises a binder resin and a conductive material.

3. The electrophotographic photoreceptor of claim 2, wherein the overcoat layer is a photocuring product of an overcoat layer-forming composition comprising a photocurable compound, a photoinitiator, a conductive material and a solvent.

4. The electrophotographic photoreceptor of claim 3, wherein the photocurable compound is selected from a mono-functional methacrylic acid ester, a bi-functional methacrylic acid ester, a tri- or higher functional methacrylic acid ester or combination thereof.

5. The electrophotographic photoreceptor of claim 3, wherein the conductive material is selected from copper, tin, aluminum, indium, silica, tin oxide, zinc oxide, titanium dioxide, aluminum oxide (Al₂O₃), zirconium oxide, indium oxide, antimony oxide, bismuth oxide, calcium oxide, ATO (antimony doped tin oxide), carbon nanotubes or combination thereof.

6. The electrophotographic photoreceptor of claim 3, wherein the overcoat layer-forming composition comprises from about 1 to about 20 weight parts of a photoinitiator, from about 5 to about 40 weight parts of conductive material, and from about 300 to about 700 weight parts of a solvent, based on 100 weight parts of the photocurable compound.

7. The electrophotographic photoreceptor of claim 1, wherein the overcoat layer has a thickness of about 0.5 to about 4 μm.

8. The electrophotographic photoreceptor of claim 1, further comprising an undercoat layer formed between the conductive substrate and the charge generating layer.

9. The electrophotographic photoreceptor of claim 8, further comprising a metal oxide layer formed between the conductive substrate and the undercoat layer.

10. The electrophotographic photoreceptor of claim 1, further comprising a metal oxide layer formed between the conductive substrate and the charge generating layer.

11. An electrophotographic imaging apparatus comprising an electrophotographic photoreceptor, a charging device charging the electrophotographic photoreceptor, an exposure device forming electrostatic latent images on the surface of the electrophotographic photoreceptor, and a developing device developing the electrostatic latent images, wherein the electrophotographic photoreceptor is the electrophotographic photoreceptor of claim 1.
